(19) United States
(12) Patent Application Publication
(10) Pub. No.: US 2015/0188272 A1
(43) Pub. Date: Jul. 2, 2015

(54) HAND TOOL FOR STRIPPING WIRE AND CRIMPING WIRE CONNECTORS

(71) Applicant: Thomas L. ESTERKIN, Prescott Valley, AZ (US)

(72) Inventor: Thomas L. ESTERKIN, Prescott Valley, AZ (US)

(21) Appl. No.: 14/184,300

(22) Filed: Feb. 19, 2014

Related U.S. Application Data
(60) Provisional application No. 61/964,328, filed on Dec. 30, 2013.

(51) Int. Cl. H01R 43/042; H02G 1/12

(52) U.S. Cl. CPC H01R 43/0421; H02G 1/1214

(57) ABSTRACT

A hand tool for stripping an electrical conductor and crimping a connector to the exposed electrical conductor includes jaws bent at a significant angle. The axis of the crimping indents and detents in the jaws are primarily perpendicular with the longitudinal axis of the hand tool. The wire stripping blade/orifices are disposed in an extension of the jaws bent at approximately 90 degrees and oriented generally parallel with the longitudinal axis of the hand tool to permit pulling on the wire toward a user and thereby facilitate stripping the wire in a confined space.

### CROSS REFERENCE TO RELATED APPLICATION

The present application includes subject matter disclosed in and claims priority to a provisional application entitled “BENT WIRE CRIMPER AND STRIPPER” filed Dec. 30, 2013 and assigned Ser. No. 61/964,328 describing an invention made by the present inventor.

### BACKGROUND OF THE INVENTION

1. Field of the Invention

The present invention relates to wire dressing tools and, more particularly, to a hand tool for stripping insulated electrical conductors and crimping electrical connectors to the stripped end.

2. Description of Related Prior Art

Most common electrical conductors include an insulating sheath for preventing direct contact with the sheathed electrical conductor (wire). Such sheaths are generally of a plastic material. The plastic material may be a relatively common plastic and flexible to permit routing of the conductor around and through various elements. The term “plastic” is used herein in a generic sense to include various types of plastic that have been or may be used for electrical insulating purposes, including sheaths made of sophisticated special purpose materials. The function of such sheaths is that of preventing electrical contact between the sheathed conductor and an adjacent object. The conductor itself may be a single strand of wire or multiple strands of wire, depending upon the nature and purpose of the conductor. Thus, the term “conductor” is used in a generic sense to include both single-strand and multi-strand wires.

To connect an end of the insulated wire to a terminal or for purposes of splicing the ends of two wires to one another, the surrounding insulating sheath must be removed for a predeterminable length along the wire. Once the length of a sheath at the end of a wire has been removed, the wire is generally attached to an electrical connector having a cylindrical section for receiving the stripped wire. The wire may be soldered to the connector or the connector may be crimped to mechanically lock the wire therewithin. Numerous hand tools have been developed to perform the function of stripping the end of a wire of its insulation and for crimping a connector to mechanically lock the end of a wire therewithin. These hand tools include a one-piece handle and jaw pivotally attached to another one-piece handle and jaw. In many cases, the jaws include pairs of blade/orifice of different sizes to accommodate different gauge wires. Upon placing an insulated wire within an appropriately sized blade/orifice pair, the insulation is cut without damage to the underlying conductor. Generally, the wire is pulled from the tool or the tool is pulled from the wire to sever the cut length of insulation and lay bare a section of the wire.

In some hand tools, the pairs of blade/orifice are disposed in the jaws of the hand tool. In other hand tools, the pairs of blade/orifice are in the handles of the hand tool.

To crimp the wire within a connector, an indent corresponding in size with the diameter of the connector may be formed in one of the jaws of the hand tool. A corresponding detent may be formed in the other jaw to create a depression in the connector upon closing the handles of the hand tool and the corresponding jaws. The resulting depression will mechanically bear against the wire within the connector and create a mechanical bond therebetween to prevent withdrawal of the wire. Multiple pairs of indents and corresponding detents may be formed in the jaws of the hand tool. Alternatively, these multiple pairs of indents and detents may be formed in the handles of the hand tool.

From the above description of existing hand tools for stripping and crimping insulated wires, the stripping function requires a lateral movement of the hand tool relative to an insulated wire extending laterally from the hand tool. Where there is sufficient space surrounding the end of the wire to be stripped and crimped, such lateral movement is of no concern. However, if such stripping and crimping must be confined within tight quarters, significant difficulty may arise.

In attempts to alleviate such problems imposed by limited space about insulated wires to be stripped and crimped, some hand tools include bent jaws containing pairs of indents/detents disposed in a bent end of the jaws of a hand tool. The stripping function is performed by the unbent portion of the jaws or by the handles, as described above. To accommodate the stripping function in confined quarters, the jaws may be bent stepwise with the step containing one or more pairs of blade/orifice. Nevertheless, the hand tool must be moved laterally to remove the cut section of insulation from the wire.

When wires are to be stripped within a confined space, such as a junction box, it is very difficult to perform the stripping function with presently available strippers. These problems occur for two reasons. The space required in a junction box or the like may not be sufficient to permit a sufficient portion of the hand tool to engage the wire to be stripped, whether the stripping function is performed by the jaws or by the handles. A second difficulty relates to the space constraints imposed in order to move the hand tool laterally to strip the insulation from the wire.

### SUMMARY OF THE INVENTION

By having the stripping function performed by 90 degree bent ends of the jaws of a hand tool, the hand tool can be drawn longitudinally out of a confined space to perform the stripping function on insulated wires therein. The crimping function, whether the pairs of indents and detents are in the bent part of the jaws, or the remaining part of the jaws, is generally easily carried out provided only that the corresponding pair of indents and detents are insertable within the confined space sufficiently to crimp a connector mounted on the stripped wire. Thereafter, the handles of the hand tool are squeezed, which does not require any lateral or longitudinal movement of the hand tool.

It is therefore a primary object of the present invention to provide a hand tool for stripping and crimping insulated electrical conductors.

Another object of the present invention is to provide a hand tool for stripping the insulation from an insulated electrical conductor by longitudinal movement of the hand tool.

Still another object of the present invention is to provide a hand tool for stripping insulated electrical conductors, which has a plurality of pairs of blades/orifices disposed in a bent part of the jaws of the hand tool.

Still another object of the present invention is to provide a hand tool for stripping and crimping insulated electrical conductors and having the stripping elements disposed in a bent section of the jaws of the hand tool and the crimping elements disposed in the remaining section of the jaws.

A further object of the present invention is to provide a method for stripping insulated electrical conductors with a hand tool by engaging the insulating sheath and drawing the hand tool along its longitudinal axis.

A yet further object of the present invention is to provide a hand tool having jaws bent at a right angle and containing elements for stripping the end of an insulated electrical conductor.

A yet further object of the present invention is to provide a hand tool having bent jaws for supporting stripping elements and crimping elements to strip an insulated electrical conductor and crimp a connector onto the stripped conductor.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 is an isometric view of a hand tool embodying wire stripping elements and wire crimping elements in the bent jaws of the hand tool;

FIG. 2 is a plan view of the hand tool shown in FIG. 1;

FIG. 3 is a side view of the hand tool wherein the jaws have a bent section bent at other than perpendicular to the longitudinal axis of the hand tool;

FIG. 4 is taken along lines 4-4, as shown in FIG. 3; and

FIG. 5 is taken along lines 5-5, as shown in FIG. 3.

### DESCRIPTION OF THE PREFERRED EMBODIMENT

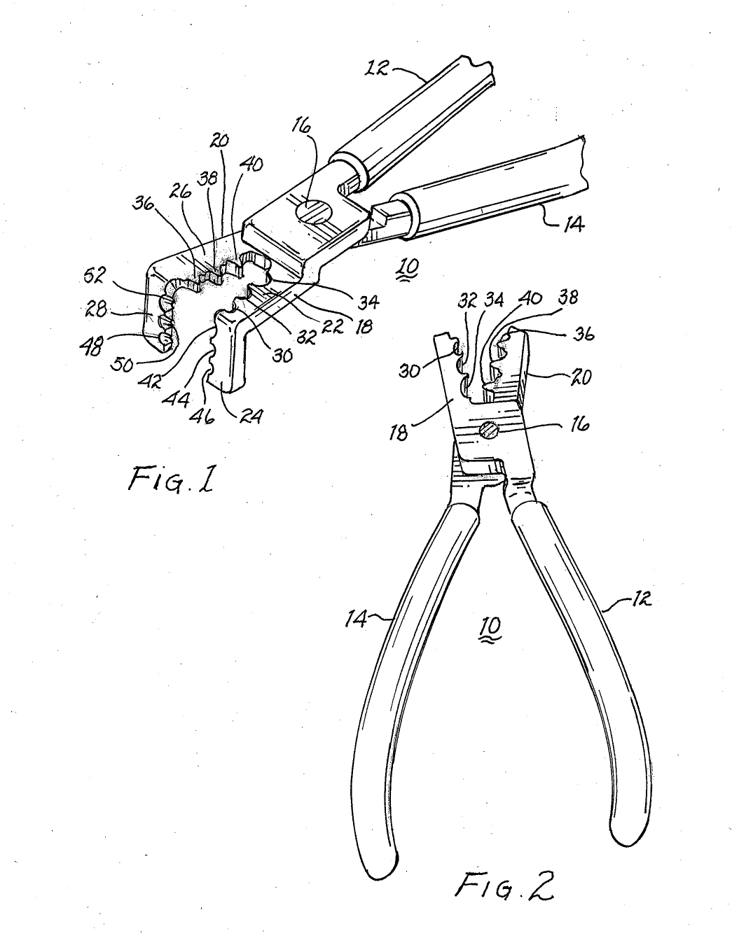

Referring to FIGS. 1 and 2, there is shown a hand tool 10 for stripping insulation from an electrical conductor and crimping a connector into engagement with the exposed conductor. The hand tool includes a pair of handles 12, 14 pivotally secured to one another by pivot 16. Handle 12 includes a jaw 18 and handle 14 includes a jaw 20. Upon bringing handles 12 and 14 toward one another, jaws 18 and 20 will close in the conventional manner. Jaw 18 includes a base 22 and an extension 24 extending from the base at an angle of approximately 90 degrees. Similarly, jaw 20 includes a base 26 and an extension 28 extending therefrom at an angle of approximately 90 degrees. Base 22 includes a plurality of indents 30, 32 and 34, each of which indents is a different size. Base 26 includes a plurality of detents 36, 38 and 40 functionally corresponding with indents 30, 32 and 34. The detents are oriented to be essentially centered on respective indents 30, 32 and 34 upon closing of jaws 18, 20. Each of indents 30, 32 and 34 is of a different size whereby connectors of different diameter can mate with a detent of essentially equivalent diameter.

Extension 24 of jaw 18 includes a plurality of blade/orifice 42, 44 and 46. Similarly, extension 28 of jaw 20 includes a plurality of blade/orifice 48, 50 and 52. Upon closing of jaws 18, 20 the blade/orifices in extension 24 mate with corresponding blade/orifices in extension 28.

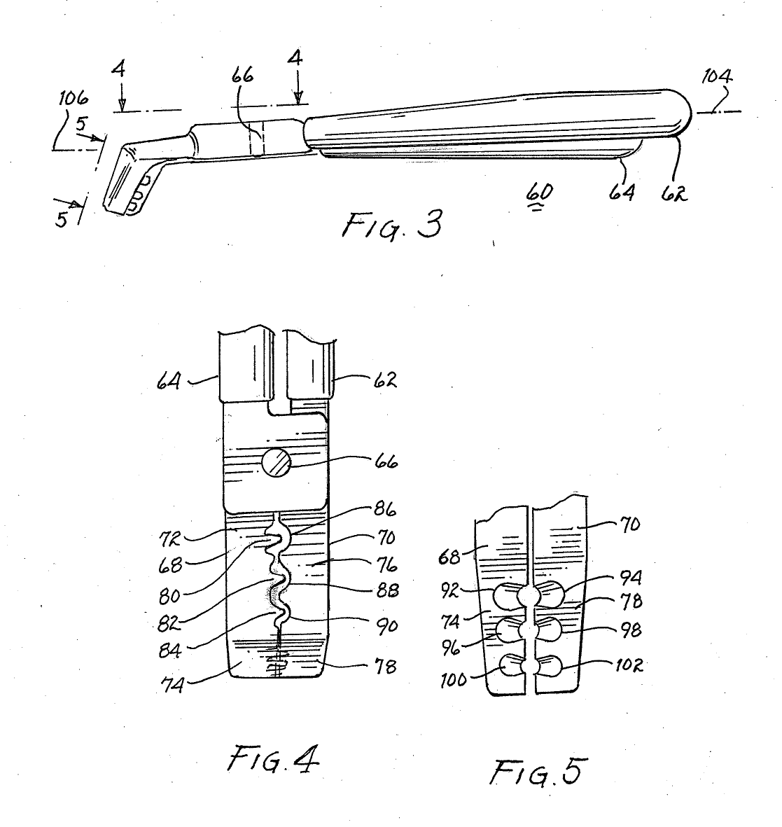

Referring jointly to FIGS. 3, 4 and 5, a variant hand tool 60 is shown in FIG. 3. The hand tool includes a pair of handles 62, 64 pivotally attached to one another by pivot 66. Handle 62 supports jaw 68 and handle 64 supports jaw 70. Jaw 68 includes a base 72 and an extension 74. Similarly, jaw 70 includes a base 76 and an extension 78. Base 72 includes a plurality of detents 80, 82 and 84. Base 76 includes a plurality of indents 86, 88 and 90. As illustrated, the indents are of different size to accommodate different diameter connectors and the detents are related in size to form a depression in a connector lodged in one of the indents upon closing of the jaws. The resulting depression will mechanically grip the length of the stripped conductor disposed within the connector.

Referring primarily to FIG. 5, there is shown a section of jaws 68, 70. Extensions 74 and 78 are shown in detail to illustrate the blade/orifices formed therein. More particularly, a blade/orifice 92 is shown in extension 74 and mates with a blade/orifice 94 in extension 78. The blade portion of each is generally a half circle of equivalent diameter to cut through the insulation surrounding the conductor. It is noted that the diameter of the wire is essentially equivalent to the diameter defined by the blades of blade/orifice 92, 94. A further blade/orifice 96 is disposed in extension 74 and cooperates with a blade/orifice 98 disposed in extension 78. The diameter represented by the semicircular blades of these blades/orifices is less than that represented by blade/orifice 92, 94 to accommodate a smaller sized conductor and ensure that the insulation thereabout is cleanly cut. A yet further blade/orifice 100 is formed in extension 74 and mates with a blade/orifice 102 formed in extension 78. The diameter of the semicircular blades is smaller yet than the blade diameters attendant blade/orifice 96, 98 to accommodate a yet smaller diameter conductor and the insulation thereabout.

FIG. 1 illustrates extensions 24, 28 of the jaws essentially at right angles to respective bases 22, 26. FIG. 3 illustrates extensions 74, 78 of the jaws at an angle other than 90 degrees and at least 30 degrees with respect to corresponding bases 72, 76. No matter how close the angle of the extensions to the respective bases is to 90 degrees, the force exerted on the hand tool to strip the insulation from an insulated conductor, whether a single-strand wire or multi-strand wire, is essentially along the longitudinal axis of the hand tool (10 or 60), as represented by segmented lines 104, 106 shown in FIG. 3.

Since the function of the indent and corresponding detent on the respective bases of the jaws require only the squeezing of the respective handles, no pulling of the hand tool is required. Thereby, the jaws can easily perform this function within even a confined space, such as a junction box or the like.

Insulated conductors having ends that must be stripped to receive and be electrically engaged by electrical connectors, which are mechanically squeezed to create a mechanical bond with an inserted conductor, come in many different gauges (sizes). Furthermore, the connectors to be attached come in many different sizes. To accommodate such variation in sizes, the number of blade/orifices disposed in the extensions may be more than the three illustrated. Similarly, the number of detents and indents for the electrical connectors may be more than the three illustrated and disposed in the base of the jaws. It is therefore to be understood that the three pairs of blade/orifices and the three pairs of indents/detents are primarily representative of a number of blade/orifices and indents/detents that may be formed in the hand tool.

Furthermore, while the above discussion has been oriented toward the use of the hand tool for stripping and crimping electrical conductors, it may also be used for wires, whether or not having a sheath throughout and crimping such wires to a connector. Like the electrical conductors, these wires may be single or multi-strand.

I claim:

1. A plier-like hand tool for stripping insulated wires and crimping wire connectors, said hand tool comprising:
(a) a pair of handles pivotally attached to one another with a pivot;
(b) a first jaw extending from one handle of said pair of handles;
(c) a second jaw extending from the other handle of said pair of handles;
(d) each of said first and second jaws including a base generally extending from and aligned with the respective handle of said pair of handles;
(e) each of said first and second jaws including an extension extending from the respective one of said bases at an angle of approximately 90 degrees;
(f) at least a pair of blade/orifices for stripping a wire disposed in said extensions of said pair of jaws; and
(g) at least a pair of indents and detents for crimping wire connectors disposed in said bases of said pair of jaws.

2. The plier-like hand tool as set forth in claim 1 wherein each pair of said indents and detents is of a different size.

3. The plier-like hand tool as set forth in claim 2 including at least three pairs of said indents and detents.

4. The plier-like hand tool as set forth in claim 1 wherein each pair of said blade/orifices is of a different size.

5. The plier-like hand tool as set forth in claim 4 including at least three pairs of said blade/orifices.

6. The plier-like hand tool as set forth in claim 2 wherein each pair of said blade/orifices is of a different size.

7. The plier-like hand tool as set forth in claim 3 wherein each pair of said blade/orifices is of a different size.

8. The plier-like hand tool as set forth in claim 2 including at least three pairs of said blade/orifices.

9. The plier-like hand tool as set forth in claim 3 including at least three pairs of said blade/orifices.

10. A plier-like hand tool for stripping an end of a wire and crimping a wire connector onto the stripped end of the wire, said hand tool comprising:
(a) a pair of jaws, each jaw of said pair of jaws including a base and an extension extending from said base at an angle;
(b) at least one pair of blade/orifices disposed in said extension for stripping wires; and
(c) at least one pair of indents and detents disposed in said base for crimping the wire connector.

11. The plier-like hand tool as set forth in claim 10 wherein the angle defined by said base and said extension in each jaw is at least 30 degrees.

12. The plier-like hand tool as set forth in claim 11 wherein the angle defined by said base and said extension in each jaw is approximately a right angle.

13. The plier-like hand tool as set forth in claim 10 wherein each said base includes at least three pairs of indents and detents for crimping a wire connector.

14. The plier-like hand tool as set forth in claim 10 wherein each said extension includes at least three pairs of blade/orifices for stripping the insulated wire.

15. The plier-like hand tool as set forth in claim 13 wherein each pair of said pairs of blade/orifices is of a different size.

16. The plier-like hand tool as set forth in claim 14 wherein each pair of said indents and detents is of a different size.

17. The plier-like hand tool as set forth in claim 15 wherein the angle defined by said base and said extension of each jaw is approximately a right angle.

18. The plier-like hand tool as set forth in claim 16 wherein the angle defined by said base and said extension of each jaw is approximately a right angle.
